(19) United States
(12) Patent Application Publication
(10) Pub. No.: US 2010/0309750 A1
(43) Pub. Date: Dec. 9, 2010

(54) Sensor Assembly

(76) Inventor: Dominic Brady, Freemantle (GB)

Correspondence Address: SCHLUMBERGER TECHNOLOGY CORPORATION;David Cate, IP DEPT., WELL STIMULATION, 110 SCHLUMBERGER DRIVE, MD1, SUGAR LAND, TX, 77478, US

(21) Appl. No.: 12/555,009

(22) Filed: Sep. 8, 2009

Related U.S. Application Data
(60) Provisional application No. 61/184,875, filed on Jun. 8, 2009.

(51) Int. Cl. E21B 47/16; G01V 1/00

(52) U.S. Cl. 367/82; 367/86; 73/152.16

(57) ABSTRACT

An assembly for passive detection of features at known locations of a conduit. The assembly is a sensor assembly particularly well suited for detection of casing collars at known locations of cased wells, such as segmented hydrocarbon wells. Thus, the assembly is able to provide real time positioning information relative to any tool coupled thereto which is being advanced in the well pursuant to a well application. Given that the detection takes place in a passive manner via the combination of a magneto-responsive sensor and voltage responsive device, no separate dedicated power source or additional electronics are required.

### CROSS REFERENCE TO RELATED APPLICATION

This Patent Document claims priority under 35 U.S.C. §119(e) to U.S. Provisional Application Ser. No. 61/184,875 entitled High Sensitivity Optical Casing Collar Locator, filed on Jun. 8, 2009, and incorporated herein by reference in its entirety.

### FIELD

Embodiments described relate to a sensor and techniques for establishing and monitoring a position of a tool through a conduit. In particular, techniques are described that minimize the amount of footspace that may be required by the sensor in acquiring and transmitting locating information over a fiber optic line.

### BACKGROUND

Exploring, drilling and completing hydrocarbon and other wells are generally complicated, time consuming and ultimately very expensive endeavors. In recognition of these expenses, added emphasis has been placed on well logging, profiling and monitoring of well conditions. Over the years, the detecting and monitoring of well conditions has become a more sophisticated and critical part of managing well operations.

Initial gathering of information relative to well and surrounding formation conditions may be obtained by running a logging tool in the well. The logging tool may be configured to acquire temperature, pressure, acidity and other well condition information. A map of the acquired information may be generated resulting in an overall profile of the well which may be of great value in servicing and maintaining the well. In order to generate an accurate profile, the true position of the tool in the well should be known throughout the logging operation. In this manner, proper correlation of acquired data and well location may be available for generating an accurate profile. Of course, even outside of a particular logging operation and profile generation, the need for accurate understanding of tool positioning within a well remains. For example, more active interventional operations such as well perforating, clean out operations, and a host of others rely on accurate downhole tool positioning.

In circumstances of cased wells, accurate downhole positioning information is often obtained by the real-time detection of casing collars. That is, cased wells generally consist of a series of equal length casing segments jointed to one another by casing collars. So, for example, where typical 30 ft. casing segments are employed in defining the inner wall of a cased well, a casing collar may be found every 30 feet throughout the well. As such, casing collar locator tools have been developed for running in the well in conjunction with application tools such as for performing the above noted log. In this manner, casing collar detection may be acquired as the application tool is advanced through the well. Thus, accurate positioning of the application tool may be ascertained.

Conventional casing collar locator tools include a magneto-responsive assembly that has a coil disposed between magnets within a housing. Thus, as the housing passes a casing collar, the additional metallic collar material that is magnetically sensed may translate into voltage from the coil. As such, a signal may be generated that is sent uphole and detected at the surface. In most circumstances, this type of signaling is electronically communicated over a line to the surface.

The above-described conventional casing collar locator tool provides a good deal of accuracy in terms of collar location. Thus, accuracy in terms of application tool positioning may also be attained. Unfortunately, however, the described locator tool also requires a fairly significant power source and associated electronics in order to convert downhole collar detection into a discernable signal at the surface. Indeed, in most circumstances the locator tool may include an associated 5-10 foot long lithium battery pack. Not only does such significant footspace drive up tool expense (e.g. generally about $7,000 per foot in today's pricing), but the long term reliability of the battery and electronics packaging is less than desirable. For example, even the best of batteries will generally last no more than about 6 months with regular use. Given the high temperatures and overall harshness of the downhole environment, the battery and electronics packaging is unlikely to survive even this duration of regular use.

With such battery and electronics packaging challenges in mind, efforts have been made to improve powering means for downhole collar locators. However, these efforts have remained focused on factors such as reducing battery sizing, and improving battery life and/or protection. Regardless, battery life generally falls short of 50-60 hours of use. Additionally, such efforts fail to address safety concerns in terms of lithium battery handling and disposal or the above noted costs associated with battery expense. Furthermore, there are inherent limitations as to the degree of improvement that is attainable in terms of battery life. Indeed, at present, powering options for a conventional collar locator remain limited to a host of relatively expensive, fairly large, and ultimately unreliable options over the long term.

### SUMMARY

A sensor assembly is provided that is configured for positioning in a conduit in order to detect a change at a wall thereof. The assembly includes a magneto-responsive sensor for detecting the change as well as a voltage-responsive device coupled thereto. The sensor is configured to impart a voltage to the device upon detecting a change at a wall of the conduit. The voltage responsive device is likewise configured for dimensionally altering in response to the voltage. Lastly, a fiber optic line is coupled to the device such that light passing therethrough may be detectably affected in response to the dimensional altering of the voltage responsive device.

### BRIEF DESCRIPTION OF THE DRAWINGS

FIG. 1 is a side view of an embodiment of a sensor assembly disposed adjacent coiled tubing and a logging tool.

FIG. 2 is an overview of the sensor assembly of FIG. 1 deployed in a well at an oilfield.

FIG. 3 is a schematic representation of the sensor assembly of FIG. 1 with fiber optic line coupled thereto.

FIG. 4 is a chart revealing information obtained by the sensor assembly of FIG. 1 as it is passed through the well of FIG. 2.

FIG. 5 is a flow-chart summarizing an embodiment of employing a sensor assembly such as that of FIGS. 1-4.

### DETAILED DESCRIPTION

Embodiments are described with reference to certain sensor assemblies for detection of downhole casing collars in a hydrocarbon well. As such, embodiments are generally depicted as casing collar locator assemblies for establishing accurate positioning of associated downhole tools. However, a variety of configurations may be employed. For example, sensor assembly embodiments as described herein may be employed for detection of wall features in a variety of wells, pipes, or other appropriate conduits. Regardless, embodiments described herein are employed that utilize a dimensionally alterable voltage responsive device. As detailed herein, where appropriately configured, such a piezo-like device may obviate the need for coupling a separate dedicated power source to the sensor assembly. Thus, a significant amount of footspace may be saved while at the same time improving the overall longevity and reliability of the assembly.

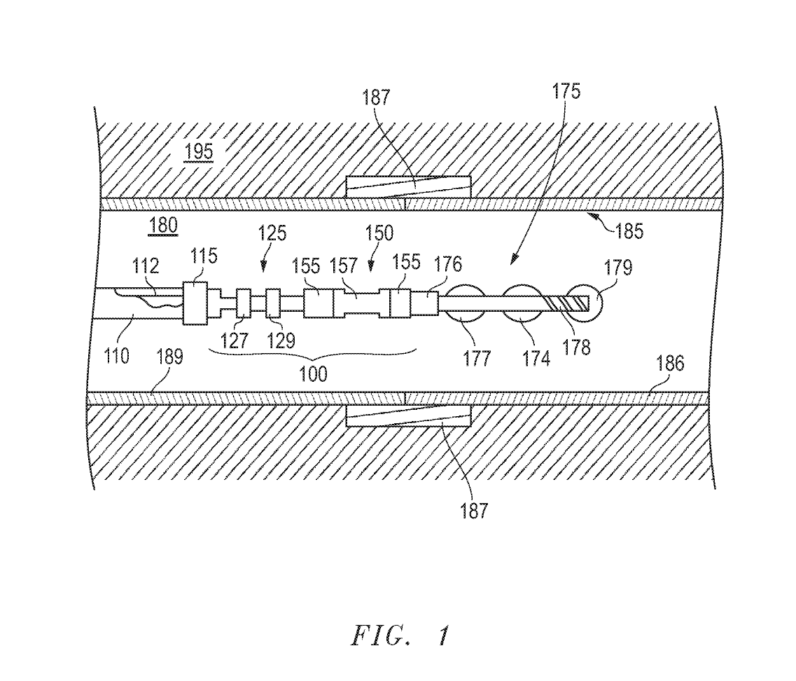

Referring now to FIG. 1, downhole equipment is shown disposed in a hydrocarbon well 180. More specifically, coiled tubing 110 is depicted as delivering an embodiment of a sensor assembly 100 and application tool 175 to the location shown. In the embodiment depicted, the application tool 175 is a passive logging tool for determining a variety of well conditions as noted below. However, active tools for interventional applications may also be employed such as perforating guns and/or clean out tools. Regardless, in order to properly assess the position of any such tool 175 in conjunction with gathering of well information, the sensor assembly 100 has been provided.

As detailed below, the sensor assembly 100 is configured to operate without the use of significant electronics or a dedicated downhole power supply. To the contrary, the assembly 100 is equipped with a magneto-responsive sensor 150 that is configured for the passive detection of a downhole casing collar 187 at a known location. The sensor 150 in turn is coupled to a voltage responsive device 125 that is configured for signaling over a fiber optic line 112 without the requirement of a separate power source. As a result, several feet of downhole electronics and dedicated powering equipment may be left out of the assembly 100. Accordingly, the assembly 100 of the embodiment shown may be substantially less than the conventional 6-8 feet in length. Preferably, the assembly 100 is no more than about 2 feet in length. Such is made possible by the configuration of the voltage responsive device 125 as detailed further herein.

Continuing with reference to FIG. 1, the logging application tool 175 may be equipped with optically compatible measurement tools (e.g. movement detector 176, saturation implement 177, ejector implement 178, imaging device 174, fullbore spinner 179, etc.). A variety of other optically compatible diagnostic implements may also be accommodated by the tool 100 for establishing pressure, temperature, hydrocarbon states and other well conditions including surrounding formation data throughout the well 180. Regardless, the presence of the sensor assembly 100 coupled to the tool 175, allows the acquired logging data to be utilized in mapping an accurate profile of well conditions. Additionally, during the application, the acquired information may be real time in nature. Thus, real time use of such information may be employed with a degree of location accuracy. For example, where afforded by additional downhole equipment not depicted here, certain site specific interventional applications may be pursued in conjunction with the logging application. These may include the shutting off of a particularly located downhole valve or sliding sleeve, the perforating or clean out of a particular well location or a host of other active interventional applications. Whatever the case, such real time intervention may take place with a significant degree of accuracy in terms of the location in the well 180.

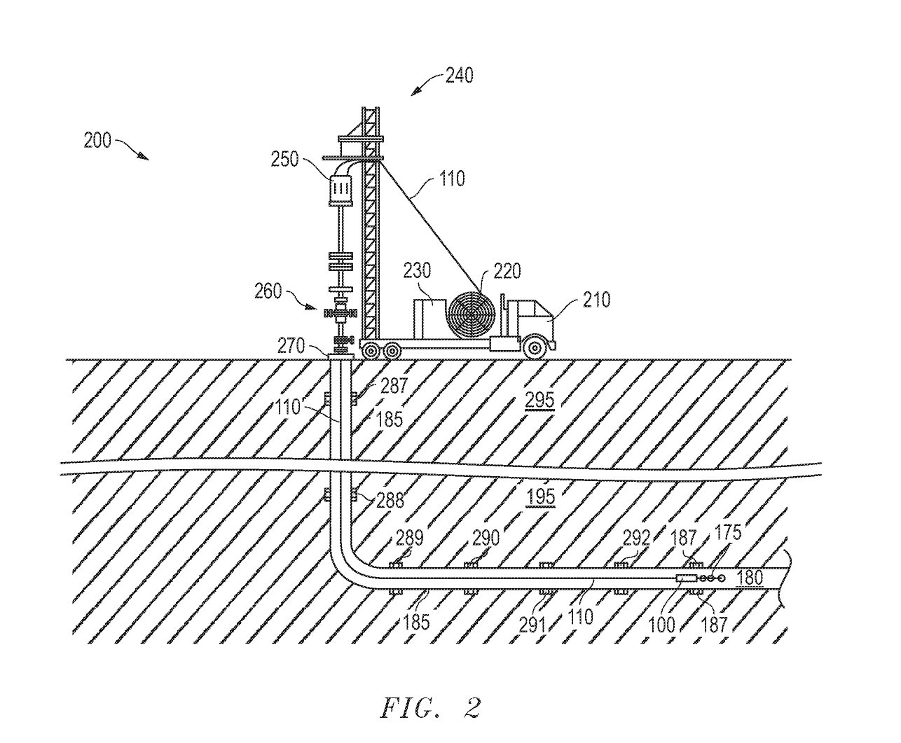

In the embodiment shown, the sensor assembly 100 and application tool 175 are delivered to the depicted location via coiled tubing 110. Downhole communication, at least with respect to the sensor assembly 100, is achieved over a fiber optic line 112. The line 112 may be a single fiber or a bundle of fiber optic fibers for communicating back and forth between the assembly 100 and surface equipment such as a control unit 230 as shown in FIG. 2. A downhole tractor or other device may also be employed to aid downhole conveyance. Additionally, other modes of delivery may be employed altogether. For example, wireline delivery may be employed where the well 180 is substantially vertical in nature.

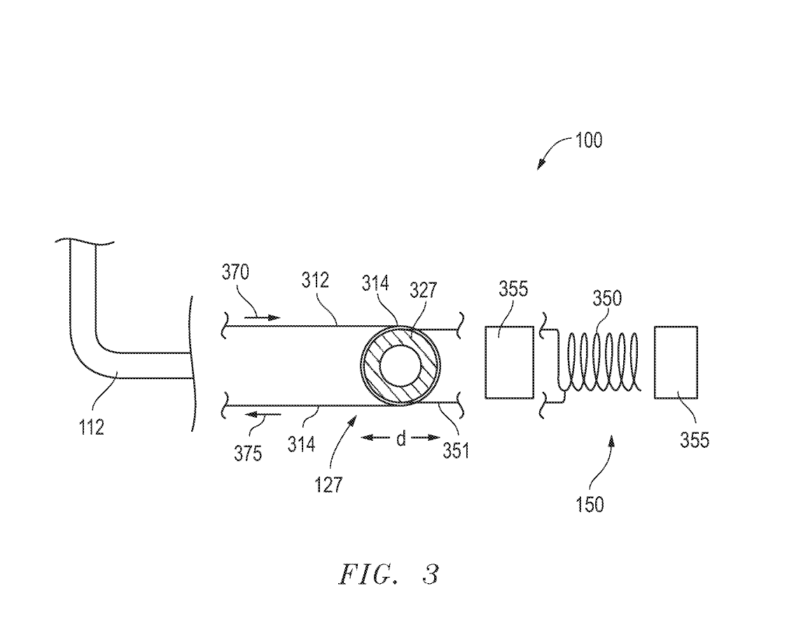

Continuing with reference to FIG. 1, the sensor assembly 100 itself is made up of the magneto-responsive sensor 150 which is coupled to the voltage responsive device 125. The sensor 150 includes a coil housing 157 with a magnet housing 155 disposed at either side thereof. Indeed, with brief added reference to FIG. 3, the housings 157, 155 contain an actual coil 350 disposed between separate magnets 355. In this manner, a discernable voltage may be directed through the coil 350 as the sensor passes by a casing collar 187. As detailed further below, this voltage may ultimately be employed to dimensionally affect the voltage responsive device 125 in a manner that may be detected and communicated across the fiber optic line 112 without the need for dedicated power or additional electronics.

The voltage responsive device 125 noted above is made up of multiple voltage responsive cylinders 127, 129 which are each coupled to the coil 350 of FIG. 3 as well as the fiber optic line 112. As detailed further below, the dimensional responsiveness of the cylinders 127, 129 to voltage from the coil 350 may affect light passing through the fiber optic line 112 in a detectable manner. That is, as the assembly 100 passes a casing collar 187 and is detected by the sensor 150, an indication of such detection is simultaneously communicated uphole over the line 112.

Continuing now with reference to FIGS. 1 and 2, the well 180 is defined by a casing 185 running through formation layers 195, 295. The casing 185 is segmented, made up of a series of casing segments, such as the segments 186, 189 depicted in FIG. 1. As a matter of stabilization, a casing collar is threadably disposed about the interface of adjoining segments throughout the well 180. Again, such is the case with the casing collar 187 of FIG. 1 at the interface of segments 186 and 189. A host of additional casing collars 287, 288, 289, 290, 291, 292 are apparent in the overview of FIG. 2 as well.

With particular reference to FIG. 2 and the above architecture in mind, each casing collar 287, 288, 289, 290, 291, 292, 187 may be distanced from an adjacent collar by a known distance. For example, conventional casing 185 for a hydrocarbon well 180 is generally available in 20-40 foot segments 186, 189 (more specifically about 30 feet each). Thus, a known separation of 30 feet exists between adjacent collars 287, 288, 289, 290, 291, 292, 187 which may be accounted for as the assembly 100 is advanced through the well 180.

As depicted in FIG. 2, the assembly 100 is shown delivered by way of coiled tubing 110 from a coiled tubing truck 210 at the surface of an oilfield 200. More specifically, the truck 210 accommodates a coiled tubing reel 220 and control unit 230 which may be used to mobily deploy and regulate the delivery of the coiled tubing 110 through a rig 240 and other surface equipment as depicted. As described below, the control unit 230 in particular may make use of the known distance between casing collars 287, 288, 289, 290, 291, 292, 187 so as to enhance the accuracy and reliability of the depicted logging application. It is also worth noting that the sensor assembly 100 is up to 30,000 feet or more from the surface of the oilfield 200 and yet, as described herein, fiber optic communication is reliably achieved without the requirement of dedicated power and/or electronics. As such, concern over damage to such electrical components, for example, due to the harshness of the well environment or the delivery application itself, is entirely avoided.

Continuing with reference to FIG. 2, the coiled tubing is threaded through a gooseneck injector 250 and directed toward an assembly of pressure regulation and control valves 260 often referred to as a ‘Christmas Tree’. From there the coiled tubing 110 is directed through the well head 270 and through various formation layers 295, 195 and to the location shown.

As the coiled tubing 110 is advanced, the above described control unit 230 may be configured to acquire information from the assembly 100 and application tool 175. Additionally, information such as the known distance between casing collars 287, 288, 289, 290, 291, 292, 187 may be pre-stored on the unit 230 so as to ascertain the location of the assembly 100. As such, more accurate positioning of the assembly 100 may be realized in real time. Accordingly, the application may proceed with a greater degree of accuracy and, for the logging application of FIGS. 1 and 2, a more accurate profile of the well 180 may be developed.

Referring now to FIG. 3, a schematic representation of the sensor assembly 100 is shown. In this view, the internal mechanics of a voltage responsive cylinder 127 of the voltage responsive device 125 of FIG. 1 is detailed. Namely, voltage responsive or ‘piezo’ material 327 is depicted as in contact with a coil extension 351 emanating from a coil 350 of the magneto-responsive sensor 150. As noted above, magnetically induced voltage through the coil 350 from the magnets 355 of the sensor 150 may be translated into dimensional change in the material 327. Ceramics such as lead zirconate or other suitable voltage responsive materials may be employed as the piezo-material 327.

In practical terms, with reference to the embodiments depicted in FIGS. 1-3, voltage may be delivered by the coil 350 (via an extension 351 thereof) to the piezo-material 327 as a casing collar 187 such as that of FIG. 1 is detected by the sensor 150. This voltage may be up to a few volts. Preferably about a volt will more than suffice. Regardless, as a result of such imparted voltage, the material 327 may expand (or contract, depending on the electrical architecture employed between the coil 350 and the material 327).

Continuing with reference to FIG. 3, one embodiment of the voltage responsive cylinder 127 with embedded piezo-material 327 may be of a truly cylindrical configuration as shown. In such an embodiment, the cylinder 127 may be 30-50 mm in outer diameter (d), preferably about 40 mm, without exposure to voltage. However, once a casing collar 187 (see FIG. 1) is detected, the voltage imparted on the material 327 may increase the outer diameter of the cylinder 127 by a distinguishable amount as detailed further below, say 1-3 nanometers. Thus, given that the material 327 is firmly wrapped by fiber optic fibers 312, 314 of the line 112, the dimensional change in the cylinder 127 may result in a stretching out the fibers 312, 314. As a result, light that is transmitted downhole (see arrow 370) over the downhole fiber 312 of the line 112 may be altered.

Where a conventional interferometer is employed to reflect the above-noted light back uphole (see arrow 375), the change in the light may be detected and accounted for at surface. In one embodiment, the interferometer is a 10-15 m interferometer coupled directly to a location of the voltage responsive device 125. Additionally, the noted accounting of uphole light may take place at the control unit 230 described above (see FIG. 2). All in all, casing collar detection of this nature may be enhanced in terms of downhole tool positioning accuracy.

In the schematic of FIG. 3, a single voltage responsive cylinder 127 is depicted as detailed above. However, in other embodiments an additional voltage responsive cylinder 129 may be employed (see FIG. 1). In such an embodiment, the effect on light travelling uphole over the uphole fiber 314 (see arrow 375) may be magnified. Alternatively, the electrical architecture between the coil 350 and each cylinder 127, 129 may be oppositely configured. Thus, voltage on one cylinder 127 may result in expansion whereas voltage on the other cylinder 129 results in contraction. In this manner, the overall sensitivity of the device 125 may be improved and a degree of noise cancellation may be achieved, such as where other dimensional changes result from common mode signals (e.g. temperature and other environmental well condition factors).

Given that the dimensions of a cylinder 127 are known ahead of time, the dimensional change upon a voltage imparted to the piezo-material 327, may be correlated directly with a wavelength change in light. For example, with a conventional diode or other laser light source employed at surface through the fiber optic line 112 of FIG. 1, a downhole path of light (see arrow 370) of a given wavelength is generated. As detailed above, this light may pass through fibers 312, 314 that are wrapped about the dimensionally responsive piezo-material 327 and reflected back uphole (see arrow 375). However, this return light may be of a different wavelength.

Computations may be performed by the control unit 230 of FIG. 2 which may employ conventional algorithms which account for in correlating the wavelength change to the dimensional changes in the fibers 312, 314 and the overall cylinder 127, thereby verifying collar detection. For instance, in one such example, the fibers 312, 314 may be comparatively flexible relative to the underlying piezo-material 327. Thus, they may be presumed to have substantially no effect on expansion of the material 327. As such, depending on the particular material type selected for the piezo-material 327, an expected displacement reduction of between about 5-7% may be exhibited by the fibers 312, 314 upon collar detection. With such data pre-stored at the control unit 230 along with detail regarding the interferometer utilized in sending the optical signal back uphole (see arrow 375), conventional calculations may be performed employing such data so as to verify collar detection with a degree of certainty. Once more, just as with the return signal itself, all of these calculations take place without the requirement of dedicated electronic equipment disposed at the sensor assembly 100. Additionally, such real-time verification may allow for the control unit to make application modifications in real-time (e.g. speed adjustments).

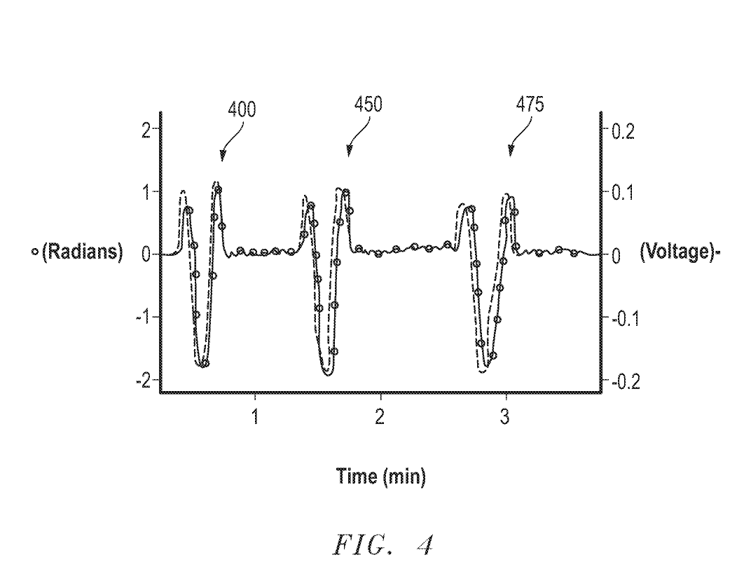

Referring now to FIG. 4, with added reference to FIGS. 1-3, a chart is shown summarizing the results of employing an embodiment of a sensor assembly 100 as detailed hereinabove. The chart depicts sensor related activity over the course of several seconds. For example, as the sensor assembly 100 is advanced downhole within the well 180, a host of casing collar detections 400, 450, 475 may be made. In the example depicted, casing collars 287, 288, 289, 290, 291, 292, 187 may be distanced from one another by a standard 30 feet or so. Thus, with a detection 400, 450, 475 taking place about once a second, it is apparent that downhole advancement speed of the sensor assembly 100 is occurring at about 30 ft. per second.

The chart of FIG. 4 specifically reveals the dimensional change of a voltage responsive cylinder 127, represented in radians (o) as the assembly 100 passes a series of casing collars 287, 288, 289, 290, 291, 292, 187. The cart also reveals the voltage (−) that is imparted to the piezo-material 327 over this same period of time. With such representations of radians (o) and voltage (−) overlaid on the same chart as in FIG. 4, the direct correlation between the voltage (−) and radians (o) is immediately apparent. Indeed, even within the detections 400, 450, 475 themselves, the dimensional expansion and contraction of piezo-material 327 follows the change in voltage (−). That is, as the magneto-responsive sensor 150 approaches a casing collar 187 a small spike may present, followed by a significant voltage detection dip and eventually another small spike as the sensor 150 continues to move away from the collar 187. Additionally, throughout such a detection period, the dimensional change (in radians (o)) very closely tracks the voltage as is apparent on the chart.

With the degree of correlation between voltage (−) and dimensional change of the cylinder 127 as noted above, the reliability of the assembly 100 is apparent. Indeed, the reliability of utilizing a relatively passive generation of voltage to trigger a dimensional change that may ultimately actuate uphole signaling is confirmed. That is to say, without the employment of any dedicated downhole power source or electronics for the assembly 100, the unique combination of a magneto-responsive sensor 150, voltage responsive device 125 and fiber optic line 112, may provide significantly accurate real time collar detection. Such a combination not only eliminates the requirement of separate dedicated power and electronics, but the combination is one that is solid state in nature. That is, no moving or adjustable parts are required in implementation.

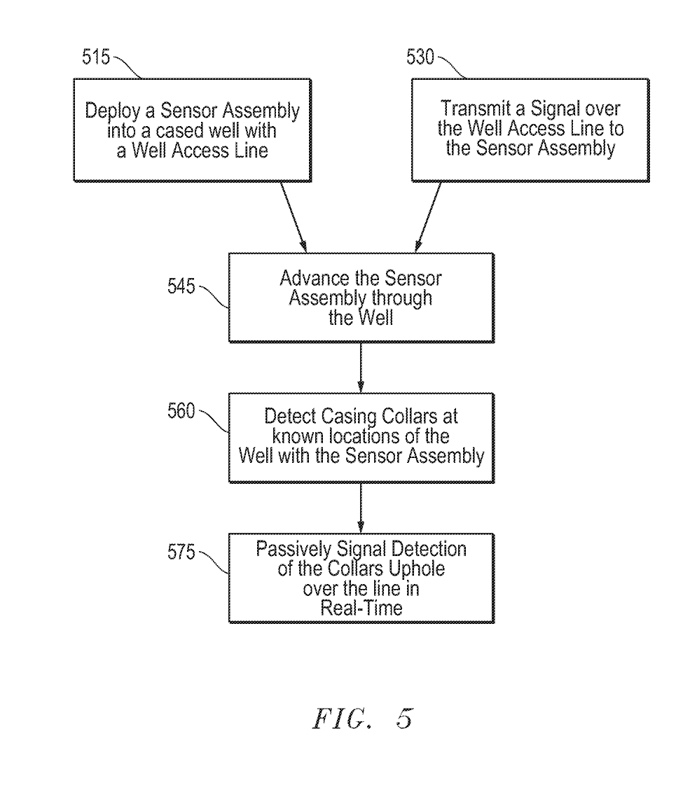

Referring now to FIG. 5, a flow-chart summarizing the use of a sensor assembly as detailed above is shown. For example, the assembly is deployed into a cased well as indicated at 515. Embodiments described above utilize coiled tubing as a well access line for such deployment. However, other types of delivery line may be employed. Additionally, an application tool and downhole application may be run in conjunction with the noted deployment and subsequent advancement of the assembly. Also, as indicated at 530, a signal such as light may be transmitted over the line to the sensor assembly as it is deployed and later advanced. For example, in the embodiments described herein, laser light over fiber optics of the line are employed.

As alluded to above, the assembly is advanced through the well and employed to detect casing collars at known locations thereof (see 545, 560). This detection may be initiated by a magneto-responsive sensor of the assembly which may indicate real-time collar detection by routing of signal back uphole over the line. As indicated at 575, this routing of signal may be deemed ‘passive’ in the sense that no dedicated power is required for the routing of the collar detection signal uphole. Rather, through use of a conventional interferometer and dimensionally alterable voltage responsive device, a light signal may be reflected uphole that is indicative of collar detection without any added power requirement or conversion electronics necessary. Indeed, such passive real-time collar detection may be utilized to provide real time location information for accurate employment of an associated application tool such as a logging or well intervention tool.

Embodiments described hereinabove overcome dedicated battery and electronics packaging challenges associated with conventional casing collar locating sensors. Indeed, all such challenges are overcome in the sense that dedicated battery and electronics packing are rendered unnecessary for embodiments of the sensor assembly described herein. As a result, substantial improvement may be realized in terms of cost savings and long term reliability of the sensor assembly. Even handling safety of the assembly is improved due to the lack of a dedicated lithium-based battery or other hazardous power source.

The preceding description has been presented with reference to presently preferred embodiments. Persons skilled in the art and technology to which these embodiments pertain will appreciate that alterations and changes in the described structures and methods of operation may be practiced without meaningfully departing from the principle, and scope of these embodiments. For example, sensor assemblies as detailed herein are directed at collar detection for segmented hydrocarbon casing. However, sensor assemblies as described herein may be employed in conjunction with other well or conduit types employing magnetically detectable features at known locations, such as is often the case for cased water wells. Furthermore, the foregoing description should not be read as pertaining only to the precise structures described and shown in the accompanying drawings, but rather should be read as consistent with and as support for the following claims, which are to have their fullest and fairest scope.

I claim:

1. A sensor assembly configured to be disposed in a conduit for detecting a change at a wall thereof, the assembly comprising:
a magneto-responsive sensor for the detecting;
a voltage responsive device coupled to said sensor, said sensor configured for imparting a voltage thereto upon the detecting, the imparting for dimensionally altering said device; and
a fiber optic line coupled to said device, said device configured for detectably affecting light passing through said fiber optic line upon the altering.

2. The sensor assembly of claim 1 wherein the conduit is a cased well.

3. The sensor assembly of claim 2 wherein the cased well comprises:
casing segments; and
a casing collar at a known location for interfacing of said segments, said collar accounting for the change.

4. The sensor assembly of claim 1 wherein the imparting, the altering, and the affecting are passive.

5. The sensor assembly of claim 1 wherein said magneto-responsive sensor and said voltage responsive device are of a single solid state configuration.

6. The sensor assembly of claim 1 wherein said magneto-responsive sensor comprises:
a metal coil disposed between multiple magnets; and
a coil extension coupled to peozo-material of said voltage responsive device.

7. The sensor assembly of claim 6 wherein said fiber optic line comprises downhole light carrying fiber disposed about the piezo-material and uphole light carrying fiber disposed about the piezo-material, an interferometer positioned therebetween for reflecting downhole light back as uphole light, the affecting of the light through said line comprising a wavelength difference between the downhole and uphole light.

8. The sensor assembly of claim 6 wherein said voltage responsive device is a first voltage responsive device, the sensor assembly further comprising a second voltage responsive device with peizo-material electrically coupled to said metal coil, said sensor configured for imparting a voltage thereto upon the detecting, the imparting for dimensionally altering said second voltage responsive device.

9. The sensor assembly of claim 8 configured for common mode noise cancellation with said first voltage responsive device to expand upon the altering and said second voltage responsive device configured to contract upon the altering.

10. A voltage responsive device comprising:
a housing;
piezo-material disposed in said housing and electrically coupled to a magneto-responsive sensor configured for voltage generation upon detecting a well casing collar, said piezo-material wrapped by a fiber optic line for passively communicating the detecting.

11. The voltage responsive device of claim 10 wherein said peizo-material is configured for dimensionally responding to the generation for the communicating.

12. The voltage responsive device of claim 11 of a cylindrical configuration with an outer diameter of between about 30 mm and about 50 mm.

13. The voltage responsive device of claim 12 wherein the responding changes the diameter by about 1 nm to about 3 nm.

14. The voltage responsive device of claim 10 wherein said peizo-material is a ceramic.

15. The voltage responsive device of claim 14 wherein the ceramic is lead zirconate.

16. An application assembly for deployment in a cased well, the assembly comprising:
a well access line;
a sensor assembly coupled to said well access line for passively communicating therewith, said sensor assembly having a voltage generation detector for detecting a casing collar in the well and dimensionally responsive piezo-material coupled thereto for the communicating; and
an application tool coupled to said sensor assembly for performing an application in the well.

17. The application assembly of claim 16 wherein the well is one of a hydrocarbon well and a water well.

18. The application assembly of claim 16 wherein said application tool is one of a logging tool and an active interventional tool.

19. The application assembly of claim 16 wherein said well access line comprises coiled tubing with a fiber optic line disposed therein for supporting the communicating.

20. The application assembly of claim 19 wherein the fiber optic line is coupled to a light source at a surface of an oilfield adjacent the well.

21. The application assembly of claim 20 wherein the light source is a laser diode.

22. A method comprising:
deploying a sensor assembly into a cased well with a well access line;
transmitting a signal from surface over the well access line to the assembly;
advancing the assembly through the well;
detecting a casing collar of the well at a known location with a sensor device of the assembly; and
passively relaying collar detection information to surface with a voltage responsive device of the assembly coupled to the sensor device.

23. The method of claim 22 further comprising performing a well application with an application tool coupled to the sensor assembly.

24. The method of claim 23 wherein the well application is a logging application, the method further comprising mapping a profile of the well based on the logging application and the collar detection.

25. The method of claim 23 further comprising adjusting the well application in real time based on the collar detection.
